(19) United States
(12) Patent Application Publication
(10) Pub. No.: US 2022/0065757 A1
(43) Pub. Date: Mar. 3, 2022

(54) Microfluidic Device for Image Multiplexing

(71) Applicant: Leica Microsystems CMS GmbH, Wetzlar (DE)

(72) Inventors: Alex David Corwin, Niskayuna, NY (US); John Tenny Fogelberg, Issaquah, WA (US); Christine Lynne Surrette, Niskayuna, NY (US); Elizabeth McDonough, Niskayuna, NY (US); Tyler Hammond, Niskayuna, NY (US); Sara Peterson, Niskayuna, NY (US)

(21) Appl. No.: 17/005,470

(22) Filed: Aug. 28, 2020

(51) Int. Cl. G01N 1/31; B01L 3/00; B01L 7/00; B01L 9/00

(52) U.S. Cl. CPC G01N 1/312; B01L 2300/025; B01L 3/52; B01L 7/00; B01L 3/50273; B01L 3/502746; B01L 3/54; B01L 9/50; B01L 9/527; B01L 2300/0609; B01L 2300/168; B01L 2300/0851; B01L 2400/086; B01L 2300/021; B01L 2300/044; B01L 2300/18; B01L 2300/1894; B01L 2300/04; B01L 3/502715

(57) ABSTRACT

The present invention relates to a microfluidic device 100 for image multiplexing. The microfluidic device 100 comprises a base structure 110 comprising an optical window 140 and a fluid well insert 120 coupled to the base structure 110. The fluid well insert 120 is configured to retain a microscope slide 130 for mounting of a biological sample 150 within the microfluidic device 100. The fluid well insert 120 is also configured to provide a fluid to said biological sample 150. A fluid well insert lid 160 coupled to the fluid well insert 120 is also provided.

### FIELD OF THE INVENTION

The present invention relates generally to a microfluidic device for multiplex staining and imaging which enables a technique for encapsulating a mounted biological sample so as to allow for sequential in situ multiplexed image analysis of the sample based on the concept of dye cycling.

### BACKGROUND

For sequential in situ multiplexed image analysis, a biological sample such as a tissue sample or tissue microarray (TMA) needs to be stained with multiple molecular probes to investigate protein expression or spatial distribution quantitatively or qualitatively, see, for example, U.S. Pat. Nos. 7,629,125 and 7,741,046, which are hereby incorporated by reference in their entirety herein to the maximum extent permitted. The staining process may be performed manually or by using an automated slide stainer. Conventionally, such methods may require the use of a coverslip to allow for imaging of the stained sample and to provide physical protection therefor.

However, given various drawbacks associated with the use of coverslips, such as the need to manually remove them when the sample needs to be exposed to various reagents in-between various process steps, certain systems have been developed which can eliminate the need to use coverslips when imaging such biological samples. For example, various such systems are disclosed in US 2009/0253163 A1 and US 2014/0055853 A1, which are also hereby incorporated herein by reference in their entirety to the maximum extent permitted.

Additionally, in various configurations, the systems of US 2009/0253163 A1 and US 2014/0055853 A1 may incorporate, for example, a Cell DIVE™ instrument which provides a standardized automated staining, imaging and image processing workflow for multiplex imaging of slides, and which is commercially available from Cytiva™, Global Life Sciences Solutions USA LLC, 100 Results Way, Marlborough, Mass. 01752, United States of America.

Nevertheless, whilst such conventional systems provide a significant improvement upon preceding systems, there is a continuous desire to improve the usability, speed/throughput, accuracy and sensitivity of systems that are used to perform multiplexed image analysis of biological samples.

Hence, the present invention, as defined by the appended claims, is provided.

### SUMMARY OF INVENTION

According to a first aspect, the present invention provides a microfluidic device for image multiplexing. The microfluidic device comprises a base structure comprising an optical window and a fluid well insert coupled to the base structure. The fluid well insert is configured to retain a microscope slide for mounting of a biological sample within the microfluidic device. The fluid well insert is also configured to provide a fluid to said biological sample. A fluid well insert lid coupled to the fluid well insert is also provided.

The biological sample may be a sample obtained from a biological subject, including a sample of biological tissue or of fluid origin obtained in vivo or in vitro. Such samples may be, but are not limited to, tissues, fractions, and cells isolated from mammals including, humans.

By way of the fluid well insert, a fluid well may be provided adjacent to the biological sample. Advantageously, such a fluid well may be shaped and dimensioned such that it can substantially reduce fluid contact with any component that covers the well so as to reduce and/or prevent the formation of bubbles, foam, or the like within the fluid well in proximity to the biological sample. Such a fluid well insert thus enables improved imaging to be provided when using the microfluidic device and further also reduces the need to introduce the fluid therein under high pressures which might damage the biological sample.

Various other advantages of certain aspects and embodiments of the present invention are also envisaged, and will become apparent from the description that follows.

### BRIEF DESCRIPTION OF THE DRAWINGS

In the drawings:

FIG. 1 shows a microfluidic device in accordance with an embodiment of the present invention showing a covered fluid well insert attached to a base structure;

FIG. 2 shows the microfluidic device of FIG. 1 with the covered fluid well insert removed from the base structure;

FIG. 3 shows the microfluidic device of FIG. 1 in a disassembled configuration;

FIG. 4 shows the fluid well insert of FIG. 3 attached to the base structure in plan view;

FIG. 5 shows the microfluidic device of FIG. 1 in a disassembled configuration;

FIG. 6 shows the microfluidic device of FIG. 1 in an exploded view;

FIG. 7 shows an alternative fluid well insert for use in various embodiments of the present invention;

FIGS. 8A to 8C schematically show how a fluid well insert cavity may be aspirated using various embodiments of the present invention; and

FIG. 9 shows a graph illustrating how fluid depth in the fluid well insert cavity of an embodiment of the invention is related to the fluid volume therein.

### DETAILED DESCRIPTION

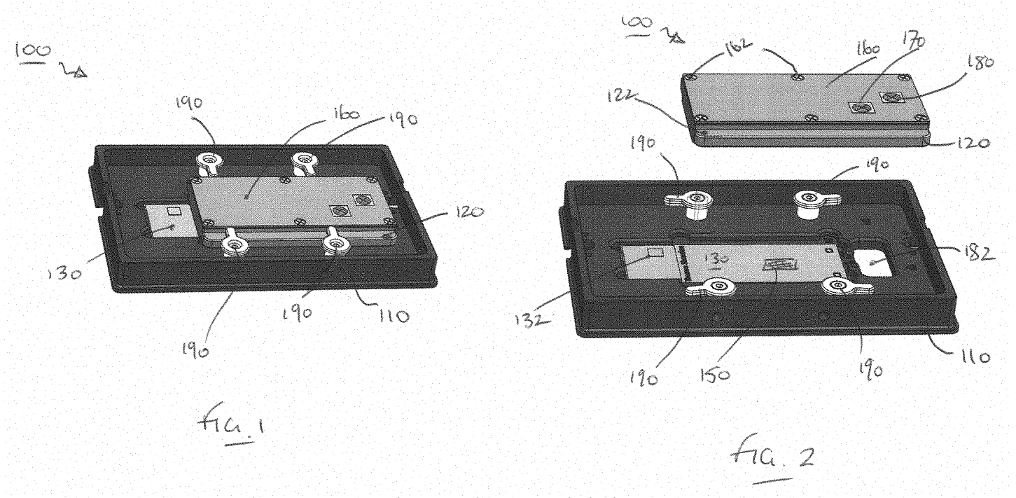

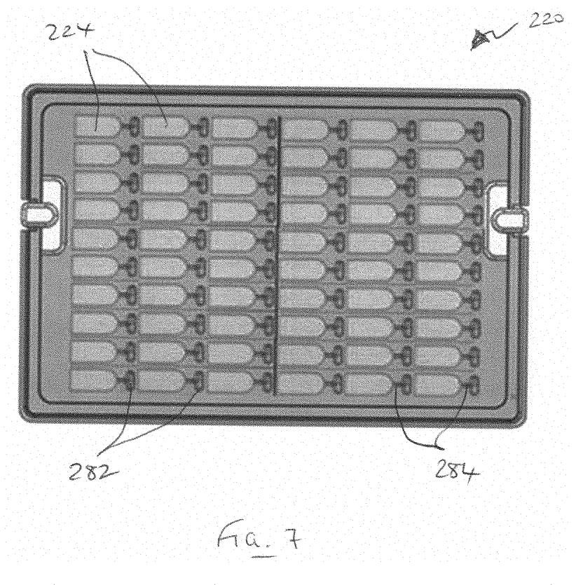

FIG. 1 shows a microfluidic device 100 in accordance with an embodiment of the present invention showing a covered fluid well insert 120 attached to a base structure 110. The base structure 110 includes an optical window 140 (see FIG. 6, for example). Fluid well insert 120 is covered by fluid well insert lid 160, which may, for example, be affixed thereto by screws 162 or the like. Preferably, the fluid well insert lid 160 comprises an opaque cover material. Such an opaque fluid well insert lid 160 thereby provides protection from background light intrusion during imaging, which can otherwise wash out the image(s) taken via the optical window 140.

Various imaging techniques may be used. For example, the biological sample may sequentially be: i) stained with a dye, ii) imaged with a high resolution microscope or fluorescent reporter, and iii) bleached or quenched, with the cycle i)-iii) then being repeated as necessary.

The base structure 110 comprises a recess for retaining a microscope slide 130 therein. The fluid well insert 120 can be coupled to the base structure 110 by way of quick release coupling mechanisms 190, and is thereby configured to retain the microscope slide 130 in the recess and provide a fluid well insert cavity 124 adjacent thereto. In use, a biological sample 150 is provided on the microscope slide 130 on a surface thereof adjacent to the fluid well insert 120 and within the fluid well insert cavity 124. The biological sample 150 is then imaged via the optical window 140.

Preferably, a portion of the microscope slide 130 remains uncovered by, and is visible adjacent to, the fluid well insert 120 when the latter is in situ, such that a labelled portion 132 remains visible during the imaging process. The labelled portion 132 may then be used to uniquely identify the biological sample 150, for example, by way of a 2-D barcode, barcode, printed text, or the like, so as to aid in automated sample processing.

The microfluidic device 100 thus provides a closed well device for housing a portion of a microscope slide with a sealed cover. Such an arrangement advantageously prevents drying and contamination of the biological sample 150. Moreover, the cover and well geometry can also provide for improved efficiency fluid dispensing and aspiration without the need to remove any covers, as will be further discussed below.

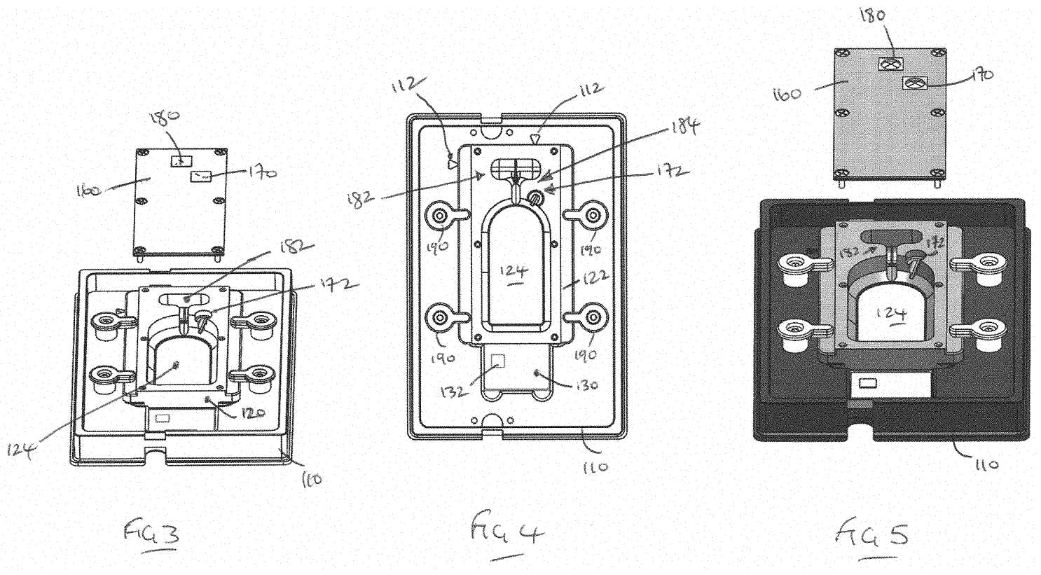

FIG. 2 shows the microfluidic device 100 of FIG. 1 with the covered fluid well insert 120 removed from the base structure 110. The fluid well insert 120 is covered by the fluid well insert lid 160 to which it is attached by means of six screws 162. Fluid well insert lid 160 further comprises a fluid inlet port 170 and a fluid aspiration port 180. Such ports 170, 180 may comprise respective slotted membranes 164 formed from resilient material, that can accommodate a pipette or syringe therein, as are known in the art. Such pipettes or syringes may be used to introduce or extract fluid(s) into or from the microfluidic device 100, for example, as part of a robotically controlled imaging process (e.g. using a robotically coupled stainer and imager, such as a Kinetix® based robot system available from Rockwell Automation, Milwaukee Wis., USA). Multiplexing reagents may also be dispersed from a dispenser (not shown) provided in fluid communication with the fluid inlet port 170.

The microscope slide 130 is shown in the recess of the base structure 110. The biological sample 150 is provided on an area of the microscope slide 130 adjacent to the labelled portion 132. The recess of the base structure 110 is also formed adjacent to a fluid aspiration cavity 182 which is fluidically coupled to the fluid aspiration port 180 when the fluid well insert 120 is in situ.

Four quick release coupling mechanisms 190 are provided. In FIG. 2, these are shown in a released position. However, when the fluid well insert 120 is in situ (as shown in FIG. 1), the quick release coupling mechanisms 190 are configured to engage with a ledge portion 122 of the fluid well insert 120 to hold it in place. The quick release coupling mechanisms 190 may be provided as swivel locks that enable efficient replacement of the microscope slide without the need to use any tools.

FIG. 3 shows the microfluidic device 100 of FIG. 1 in a disassembled configuration. Fluid well insert lid 160 is shown as being removed, whilst the fluid well insert 120 is shown in situ, being attached to the base structure 110 by way of the quick release coupling mechanisms 190.

Fluid well insert 120 provides a fluid well insert cavity 124 adjacent to the portion of the microscope slide 130 that is used to support a biological sample 150. The fluid aspiration cavity 182 is also shown fluidically connected to the fluid well insert cavity 124.

A fluid dispenser cavity 172 is also provided connected to the fluid well insert cavity 124. When the fluid well insert lid 160 is attached, the fluid inlet port 170 thereof is provided adjacent to the fluid dispenser cavity 172 in fluid communication therewith.

In various preferred embodiments, one or more channels connecting the fluid inlet port 170 with the fluid dispenser cavity 172 can be provided. Such a channel(s) may be oriented such that the fluid flow path from fluid dispenser cavity 172 towards the biological sample 150 is indirect (e.g. provides an off-axis fluid entry point) so as to minimise the disturbance to the biological sample 150 either from the force of any dispensed liquid or from any accidental contact with a pipette/syringe tip. By providing an off-axis fluid entry point/port it is possible to maintain uniformity of the, optionally opaque, fluid well insert lid 160 above the microscope slide 130. In contrast, were a fluid entry port to be provided above the microscope slide 130, it is necessary to account for possible optical differences and stray light induction due to the differences formed in the insert lid material (e.g. opaque material versus an opening).

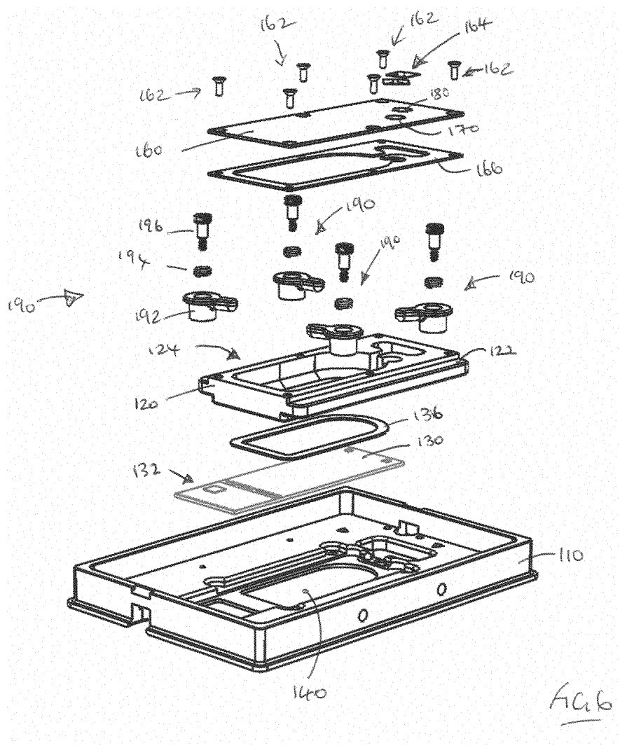

FIG. 4 shows the fluid well insert 120 of FIG. 3 attached to the base structure 110 in plan view. The base structure 110 comprises fiducial features 112 thereon. The fiducial features 112 may aid in placement of the microscope slide 130 and in aligning images thereof during the imaging process(es).

Also depicted in FIG. 4 is a fluid guide structure 184 provided between the fluid well insert cavity 124 and the fluid aspiration cavity 182. The fluid guide structure 184 is configured to help channel fluid into the fluid aspiration cavity 182 as the microfluidic device 100 is tilted. For example, tilting (either manual or automated) may be used to help with the aspiration process during aspiration of the microfluidic device 100 during a multiple stage image acquisition process.

In various embodiments, the fluid guide structure 184 may comprise a shaped (e.g. sloping) floor portion and/or a fluid dam structure configured to enable the fluid aspiration cavity 182 to retain fluid therein should the microfluidic device 100 be untilted. The fluid aspiration cavity 182 may itself incorporate a sloped floor portion (e.g. provided in a plane that is non-parallel to that of the plan view of FIG. 4), a stepped floor, or the like, to aid in preventing fluid flowing back into the fluid well insert cavity 124 during any untilting of the microfluidic device 100. For example, the fluid aspiration cavity 182 may be provided with a fluid dam that serves to keep fluid trapped, and the height of the fluid dam can be used to predefine a range of tilt angles for which fluid remains trapped therein.

Furthermore, various shaped features (e.g. one or more wing shaped features for enabling low profile tilting of the microfluidic device 100) may also be provided within the fluid well insert cavity 124 to direct fluid towards the fluid aspiration cavity 182 as the microfluidic device 100 is tilted/rocked.

FIG. 5 shows the microfluidic device 100 of FIG. 1 in a disassembled configuration as per FIG. 3. One further advantage of various embodiments of the present invention lies in the fact that the fluid well insert cavity 124 can be made relatively spacious (e.g. with a relatively low cross-sectional aspect ratio, e.g. a width to height ratio and/or length to height ratio of less than 10:1, 5:1, 3:1, 2:1, etc.), such that the fluid well insert lid 160 can be distanced from the sample. This permits the microfluidic device 100 to be operated using relatively low pressure fluids, and avoids the need to use high pressure fluid inputs which can cause sample/tissue damage and which require the use of more expensive components, e.g. pumps, and that are more prone to increased chances of leakage etc.

In one embodiment, the fluid well insert cavity 124 has a width of approximately 22 mm, a length of approximately 48 mm and a maximum depth/height of about 9 mm. A sloped wall portion may also be formed in the fluid well insert cavity 124 adjacent to a floor portion thereof, sloping into the fluid well insert cavity 124 towards the centre thereof. For example, a substantially 450 sloped wall portion may be provided extending approximately 3 mm into the fluid well insert cavity 124. Fluid may thus be provided to the top of the sloped wall portion to a depth of about 3 mm, with the fluid well insert cavity 124 having an approximate width to height ratio of 22:9 (2.4:1) and an approximate length to height ratio of 48:9 (5.3:1) respectively.

The configuration of the present invention can be used to reduce the formation of bubbles between the biological sample 150 and the fluid well insert lid 160 which can otherwise cause non-uniform staining of the biological sample 150 and thereby degrade images by introducing random image artefacts. The fluid well insert lid 160 further provides protection for the biological sample by maintaining humidity and preventing contamination during fluid treatment, imaging, transportation and storage steps.

FIG. 6 shows the microfluidic device 100 of FIG. 1 in an exploded view. Base structure 110 includes an optical window 140 therein. In this embodiment, the optical window 140 is formed as an open aperture in the base structure 110. The optical window is thus substantially transparent to electromagnetic radiation in at least one of the infrared, near-infrared, visible and/or ultraviolet spectra. However, in alternative embodiments, the optical window 140 may comprise one or more window materials for transmitting radiation at any desired wavelength, or spectra of wavelengths. The base structure also includes a recess for retaining a microscope slide 130 therein.

A first gasket 136 is provided between the microscope slide 130 and the fluid well insert 120. First gasket 136 provides a fluid-tight seal between the microscope slide 130 and the fluid well insert 120 so as to prevent fluid from escaping from the fluid well insert cavity 124. Four quick release coupling mechanisms 190 are also provided at respective corners of the fluid well insert 120 for coupling the fluid well insert 120 to the base structure 110. Each respective quick release coupling mechanism 190 incorporates a rotatable lug 192 resiliently fastened to the base structure 110 using a spring 194 and fastener 196. The spring 194 and fastener 196 thus provide a respective spring clamp attached to the base structure 110.

When rotated to engage a ledge portion 122 of the fluid well insert 120, the rotatable lugs 192 are biased into engagement therewith by respective of the springs 194. Hence, spring-loaded swivel locks are provided that enable the rapid replacement of sample-bearing microscope slides whilst also ensuring a fluid-tight seal is provided between the fluid well insert cavity 124 and the microscope slide 130.

A second gasket 166 is provided between the fluid well insert lid 160 and the fluid well insert 120 to prove a fluid-tight seal therebetween. Screws 162 are used to affix the fluid well insert lid 160 to the fluid well insert 120. Respective slotted membranes 164 are provided in the fluid inlet and fluid aspiration ports 170, 180 to provide pierceable seals therein.

FIG. 7 shows an alternative fluid well insert 220 for use in various embodiments of the present invention. The fluid well insert 220 comprises an array of respective fluid well insert cavities 224 provided in a grid-like arrangement. Each fluid well insert cavity 224 can be filled and aspirated using respective associated fluid input and fluid aspiration ports (not shown). Each fluid well insert cavity 224 is further fluidically coupled to a respective fluid aspiration cavity 282 via a fluid guide structure 284.

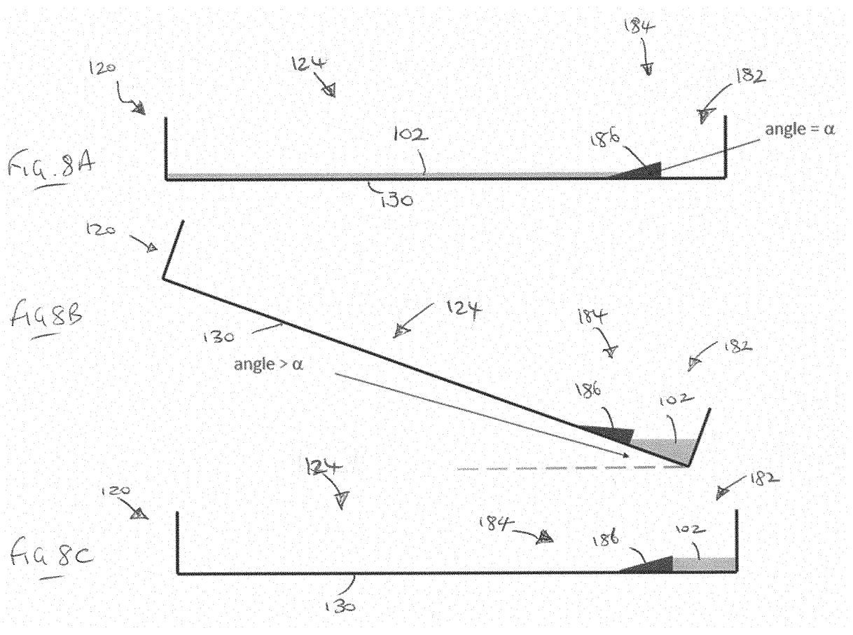

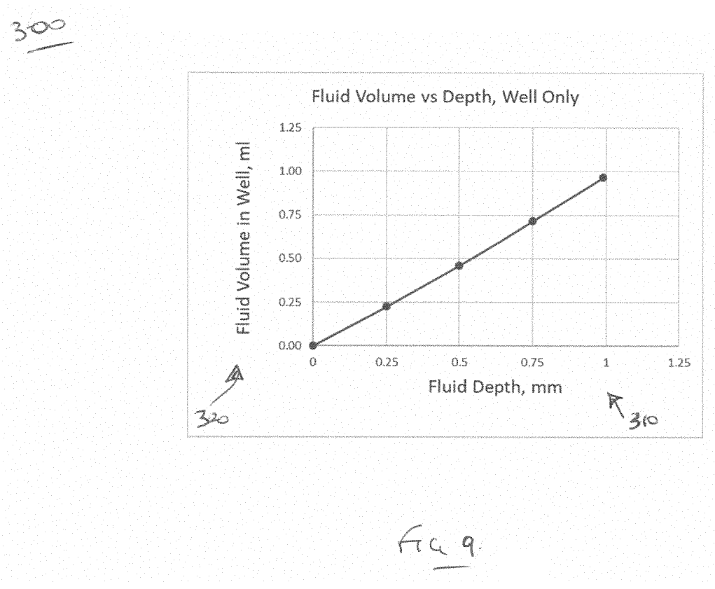

FIGS. 8A to 8C schematically show how the fluid well insert cavity 124 may be aspirated using various embodiments of the present invention.

FIG. 8A shows the fluid well insert cavity 124 when the microfluidic device 100 is in an untilted state with a fluid 102 provided therein. The fluid 102 is in contact with the biological sample 150, and may have a volume of about 50 μl, for example. The fluid well insert cavity 124 is provided by the fluid well insert 120 and is sealed at the bottom thereof by coupling to the microscope slide 130.

The fluid 102 is prevented from entering the fluid aspiration cavity 182 by way of fluid guide structure 184. Fluid guide structure 184 comprises a fluid dam structure 186 therein. The fluid dam structure 186 is formed as a wedge and has a substantially triangular cross sectional shape. Preferably, the substantially triangular cross sectional shape provides a sloped surface portion thereof angled at an angle (α) from about 10° to about 15° with respect to a floor portion of the fluid well insert 120/microscope slide 130. The height of the dam structure 186 may be chosen such that a predetermined amount of fluid can be retained in the fluid aspiration cavity 182 after tilting.

FIG. 8B shows the fluid well insert cavity 124 when the microfluidic device 100 is in a tilted state. The microfluidic device 100 has been tilted in this instance to an angle that is greater than that of the sloped surface portion of the dam structure 186 (i.e. >α).

Such a tilting action causes the fluid 102 to run over the dam structure 186 and to accumulate in the fluid aspiration cavity 182.

FIG. 8C shows the fluid well insert cavity 124 when the microfluidic device 100 has been returned to an untilted state after being tilted as per FIG. 8B. In this instance, as the microfluidic device 100 is untilted, the dam structure 186 blocks the return of fluid 102 from the fluid aspiration cavity 182 to the fluid well insert cavity 124 such that it is retained therein. Subsequently, the fluid 102 may then be aspirated from the fluid aspiration cavity 182.

FIG. 9 shows a graph 300 illustrating how fluid depth 310 in the fluid well insert cavity 124 of an embodiment of the invention is related to the fluid volume 320 therein.

In various embodiments, the fluid well insert lid 160 is configured to be spaced at a distance that is at least twice the maximum depth of fluid 102 that is to be provided in the fluid well insert cavity 124 to help prevent the formation of bubbles therein.

As is apparent from FIG. 9, the volume of fluid 320 in the fluid well insert cavity 124 varies linearly with the fluid depth 310 therein.

Various aspects and embodiments of the present invention have thus been described herein. Nevertheless many variations thereof will be apparent to the skilled person, and it is intended that these fall within the scope of the invention.

For example, a heater and/or cooler may be provided within the fluid well insert or elsewhere in the microfluidic device to enable temperature control therein to be provided. For example, one or more heaters and/or thermo-electric coolers may be incorporated.

Various embodiments of fluid well inserts may also be designed, e.g. for holding one or more volumes of reagents. For example, by including reagent wells, an insert may be provided that is pre-loaded with some of the particular stains needed for the automated multiplexing process that will be carried out on it. Well-plate structures located at edges of an insert could thus be provided which are pre-filled and covered, for example, with a pierceable film.

Moreover, whilst embodiments of the invention refer to use with microscope slides, those skilled in the art would also be aware that, for example, a tissue microarray may also be used for imaging purposes within embodiments of the invention. Furthermore, in various embodiments, a fluid well insert may be provided having a plurality of separate fluid well insert cavities provided therein, each optionally provided with a respective fluid guide structure (e.g. in a well-plate, or well-plate like, format).

However, the scope of the invention is only limited by the appended claims, when correctly interpreted with regard to the full disclosure of the present application.

1. A microfluidic device for image multiplexing, the microfluidic device comprising:
a base structure comprising an optical window;
a fluid well insert coupled to the base structure and being configured to retain a microscope slide for mounting of a biological sample within the microfluidic device, said fluid well insert being further configured to provide a fluid to said biological sample; and
a fluid well insert lid coupled to the fluid well insert.

2. The microfluidic device of claim 1, wherein the fluid well insert lid comprises an opaque cover material.

3. The microfluidic device of claim 1, wherein the fluid well insert lid further comprises a fluid input port and a fluid aspiration port.

4. The microfluidic device of claim 1, wherein the base structure further comprises at least one quick release coupling mechanism for releasably attaching the fluid well insert to the base structure.

5. The microfluidic device of claim 4, comprising a plurality of quick release coupling mechanisms each comprising a respective rotatable lug, and wherein the rotatable lugs are configured to engage with a respective ledge portion provided on said fluid well insert.

6. The microfluidic device of claim 5, wherein the rotatable lugs are provided on respective spring clamps attached to the base structure.

7. The microfluidic device of claim 1, wherein the optical window is substantially transparent to electromagnetic radiation in at least one of the infrared, near-infrared, visible and/or ultraviolet spectra.

8. The microfluidic device of claim 1, wherein the fluid well insert further comprises a fluid well insert cavity for providing a fluid in contact with the biological sample.

9. The microfluidic device of claim 8, wherein the fluid well insert further comprises one or more of: a fluid dispenser cavity in fluid communication with the fluid well insert cavity and/or a fluid aspiration cavity in fluid communication with the fluid well insert cavity.

10. The microfluidic device of claim 9, wherein the fluid well insert cavity and/or the fluid well insert further comprises at least one fluid guide structure configured to channel fluid into the fluid aspiration cavity as the microfluidic device is tilted.

11. The microfluidic device of claim 9, wherein the fluid aspiration cavity and/or the at least one fluid guide structure comprise a shaped floor portion configured to enable the fluid aspiration cavity to retain fluid therein should the microfluidic device be untilted.

12. The microfluidic device of claim 9, wherein the fluid aspiration cavity and/or the at least one fluid guide structure comprise a fluid dam structure therein.

13. The microfluidic device of claim 12, wherein the fluid dam structure has a substantially triangular cross sectional shape.

14. The microfluidic device of claim 13, wherein the substantially triangular cross sectional shape provides a sloped surface portion thereof angled at an angle (α) from about 10° to about 15° with respect to a floor portion of the fluid well insert.

15. The microfluidic device of claim 9, wherein the fluid dispenser cavity comprises at least one off axis fluid entry point therein.

16. The microfluidic device of claim 9, wherein the fluid well insert is configured to enable a labelled portion of the microscope slide to remain visible when in use.

17. The microfluidic device of claim 9, wherein the base structure further comprises one or more fiducial features provided thereon for aligning images of the microscope slide.

18. The microfluidic device of claim 9, further comprising one or more heater and/or cooler operable to control the temperature thereof.

19. The microfluidic device of claim 9, further comprising one or more reagent wells, optionally provided within the fluid well insert, wherein said one or more reagent wells are pre-loaded with stains needed for an automated multiplexing process.

20. The microfluidic device of claim 19, wherein the reagent wells are covered with a pierceable film.
